(19) United States
(12) Patent Application Publication
(10) Pub. No.: US 2023/0139654 A1
(43) Pub. Date: May 4, 2023

(54) System and Method for Exchanging Currency Change

(71) Applicant: SavCoins LLC, Mesa, AZ (US)

(72) Inventors: Austin Gurule, Mesa, AZ (US); Charlotte Gurule, Mesa, AZ (US); John Tomblin, Glendale, AZ (US)

(21) Appl. No.: 17/979,155

(22) Filed: Nov. 2, 2022

Related U.S. Application Data
(60) Provisional application No. 63/275,081, filed on Nov. 3, 2021.

(51) Int. Cl. G06Q 20/40; G06Q 20/38; G06Q 20/42; G06Q 40/12

(52) U.S. Cl. CPC G06Q 20/401; G06Q 20/3821; G06Q 20/42; G06Q 40/12

(57) ABSTRACT

A system for digitally processing cash transaction between a vendor using a vendor device and a consumer using a consumer device, wherein the transaction comprises a transaction amount and a cash amount greater than the transaction amount defining a change amount that can be the difference between the cash amount and the transaction amount. The system comprising an accounting platform on a system device comprising at least one vendor account. A vendor application program on the vendor device associated with the at least one vendor profile and comprising a vendor interface, wherein the vendor can add money to the vendor account. A processor on the system device that credits and debits vendor accounts and consumer accounts and in response to requests received from at least one of the vendor application program.

### CROSS REFERENCE TO RELATED APPLICATIONS

The present application claims the benefit under 35 U.S.C. 119 of U.S. Provisional Patent Application Ser. No. 63/275,081 filed Nov. 3, 2021. The U.S. Provisional Patent Application Ser. No. 63/275,081 is hereby incorporated by reference in its entirety

### BACKGROUND OF THE INVENTION

### Field of the Invention

The subject application is drawn to point of sale systems for retailers and more specifically to an app system that allows change amounts to be exchanged digitally.

### Description of Related Art

When a retailer makes a sale, the total amount of the sale is calculated and displayed to a buyer. If the buyer is paying in cash, the buyer gives an amount that is typically greater than the total amount of the transaction and the seller give change back to the buyer. Change can be coins, paper currency, or some combination of coin and paper currency representing the difference between the amount of the transaction and the amount given by the buyer to the seller. Change, and particularly coins given in change, are inconvenient to handle and store in a way that allows that change to remain available for future transactions. Time and resources must be spent either wrapping the change, taking it to the bank to deposit, or saving the change in a piggy bank or coin jar to convert to cash later. Sellers having to keep change on hand to give to cash purchasers must make additional bank runs to purchase loose change for their stores. Having to give change also increases the amount of contact required between a seller and a buyer allowing infectious diseases to spread more easily.

To reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

JP Pub. No. 2016/062318 to Matsumura et. al, Cash receiving saucer and commodity sales data processing unit.

JP Pub. No. 2004/227424 to Matsunami, Hirokazu, Price adjustment device. Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a system and method to allow change to be digitally returned in a cash transaction. A seller will sign up for an account and adds funds to their account, typically through a gateway credit card transaction. Deposited funds become the digital change available for the seller to disburse to customers who also sign up for an account with the system. Customers can also download a mobile app to a mobile device. When paying cash, the app will allow the seller to identify the customer account to which the change from the cash transaction is to be deposited. The seller will recognize the customer's account and the change is transferred from the sellers to the buyer's account on the system.

It is an object of the invention to reduce or eliminate the need for vendors to carry change.

It is an object of the invention to simplify vendor transactions.

It is another object of the invention to allow cash buyers to avoid carrying change.

It is another object of the invention to make cash transactions more convenient.

It is another object of the invention to allow a cash transaction combining digital and hard cash interactions.

The above and other objects may be achieved using devices involving a system for digitally processing cash transactions between a vendor using a mobile device and a consumer using a mobile device. The mobile device can be, for example, a smart phone or a tablet computer. Cash transactions typically include a transaction amount and a cash amount that is greater than the transaction amount defining a change amount that is the difference between the cash amount and the transaction amount.

In such transactions or similar transactions, an accounting platform may provide at least one vendor account associated with a vendor profile and a plurality of consumer accounts associated with a plurality of consumer profiles. Vendors may install a vendor application program and log on to have the app synced with the vendor's profile. The app may provide a vendor interface, through which the vendor can add money to the vendor account and participate in a transaction by entering the transaction amount and the cash amount into the vendor interface.

The vendor's account may be accessed by multiple authorized parties, and the vendor may use the vendor application program to manage access to the vendor account or may use a web-based application program to manage the access to the vendor account. In a particular embodiment both a device-based program and a web-based program are used to access and manage the vendor account.

Consumers may also install a consumer application program and log on to have the app synced with the consumer's profile. The consumer profile may include a consumer identifier to allow the consumer to be identified in a particular transaction. When the consumer enters into a transaction with the vendor using the platform, the consumer identifier is provided to the vendor. The consumer account may be directly transmitted from the consumer application to the vendor application or a QR code may be displayed on the consumer's device that can be read by the vendor's device.

The vendor account can include funds that are added to the vendor account through a gateway credit card transaction or a direct transfer from the vendor's outside bank accounts. When the vendor enters in the transaction amount and the cash amount involved in the transaction, the vendor account can initiate a request to debit at least some of the change amount from the vendor account and credit the same amount to the consumer account. A processor receives the request and credits and debits vendor and/or consumer accounts in response to those requests. When the consumer's account reaches a predetermined value, the processor initiates issuance of a check or credit to an outside banking account of the consumer. The predetermined value may be selected by the consumer on the consumer interface on the consumer's device.

The platform can initiate a notice to the vendor and the consumer confirming the completed transaction and tally the amount of change debited from the vendor account over a period of time, such as a day or a month. The tally may be used to true up the vendor's cash till at the end of a day or an employee's shift.

The platform is on a computing device, which can be a third-party device, cloud system, computing network, or the like, wherein the administrator can log into an administrator interface or an administrator's application program allowing an administrator to access, view, manage, and operate the accounting platform. The administrator's interface can be based on the administrator's device or may be a web-based application and may include an administrator dashboard. In other embodiments the administrator's interface can be on a mobile application used through iOS and Android systems.

The above and other objects may be achieved using methods involving at least partially eliminating change in a cash transaction between a vendor using a vendor device and a consumer using a consumer device. An accounting platform is hosted that has at least one vendor account associated with a vendor profile and a plurality of consumer accounts associated with a plurality of consumer profiles. Money can be moved into the vendor account through a gateway credit card transaction or other banking transaction. A vendor application program is distributed that is associated with the vendor profile and has a vendor interface through which the vendor can add money to the vendor account or enter the transaction amount and the cash amount. A consumer application program is also distributed that is associated with at least one of the plurality of consumer profiles and a consumer identifier that identifies the consumer account is assigned and provided to the consumer application program. Communication of the consumer identifier between the consumer device and the vendor device may be initiated in response to a prompt from the consumer device. The vendor application program and the consumer application program may be distributed as mobile apps.

The consumer application program communicates the consumer identifier to the vendor application program, and the vendor account initiates a request to debit at least some of the change amount from the vendor account and credit the same amount to the consumer account. Money can be debited from the vendor account and credited to the consumer account in response to requests received from at least one of the vendor application programs and the consumer application program. A notice may be initiated that is sent to the vendor and the consumer confirming the completed transaction.

Issuance of a check or credit to an outside banking account of the consumer is initiated when the consumer account reaches a predetermined balance. The platform may tally the amount of change debited from the vendor account over a period of time to allow the vendor to cash out their till at the end of a day or at the end of a shift. An administrator application program may be provided allowing an administrator to access, view, manage, and operate the accounting platform.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an application as installed on a user, merchants or merchant's employee using a computing device of a system and method for exchanging currency change;

FIG. 2 depicts registration process of a user, merchants or merchant's employee using a computing device of a system and method for exchanging currency change;

FIG. 3 depicts a transaction of a user, merchants or merchant's employee using computing device of a system and method for exchanging currency change;

FIG. 4 depicts merchants or merchant's employee management chart using a computing device of a system and method for exchanging currency change;

FIG. 5 depicts a sample method using a computing device of a system and method for exchanging currency change;

FIG. 6 depicts wireframe of a method or process of using a computing device of a system and method for exchanging currency change; and

FIG. 7a-7h, depicts a sample flow chart of a method or process of using a computing device of a system and method for exchanging currency change.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

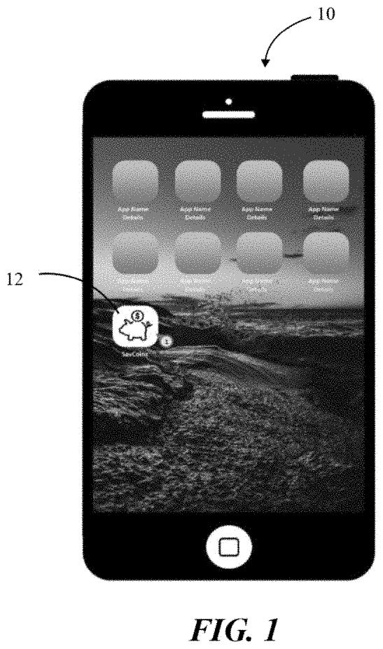

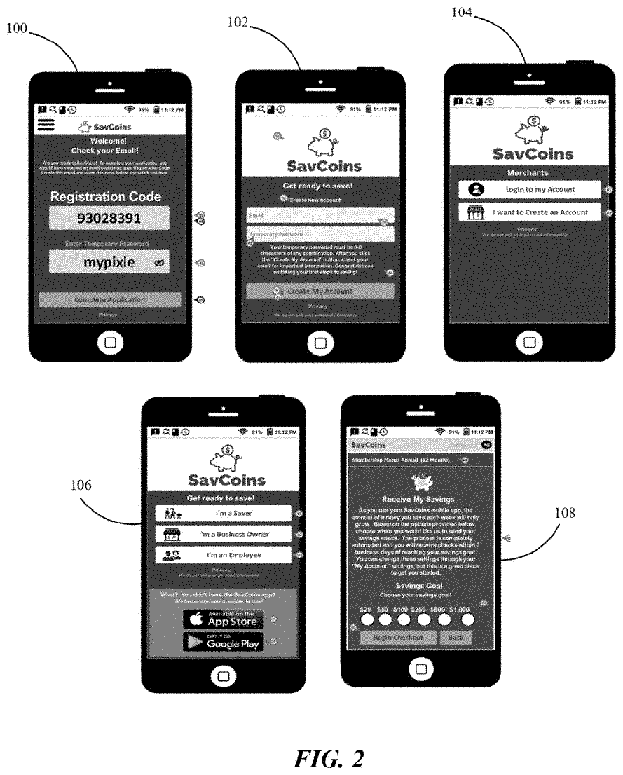

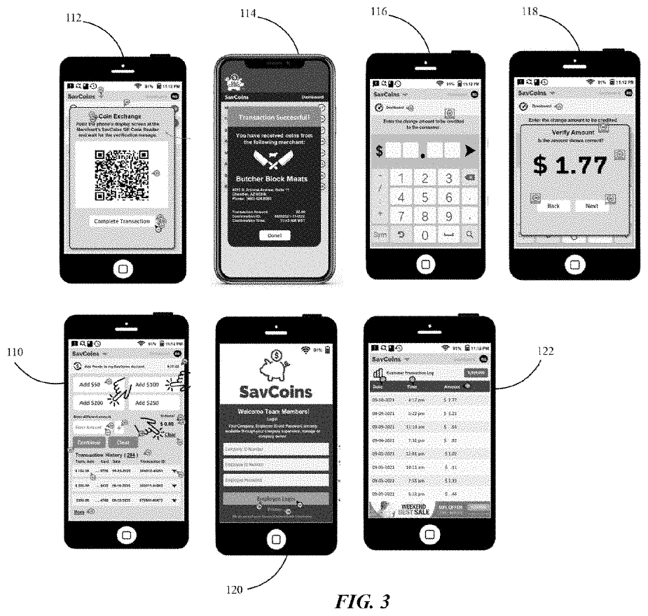

In one application of the invention, a system is provided involving a consumer, a merchant, and an administrator. A merchant who wants to enable change-saving operations signs up for a merchant account, typically through installing an app 10 on a mobile device 12 as shown in FIG. 1. The app 10 allows the merchant to sign up for an account and add funds to their account as shown in FIG. 2. At 106 the user can choose between the merchant, consumer or an employee of the merchant. At 100 a registration code is sent to the merchant, consumer or employee of merchant wherein each user can put the registration code into the app 10 the registration code and set up an account as shown in 102 or login to an existing account as shown in 104. At 108 a consumer can choose their savings goals at which point a check with be sent out to the consumer from SavCoins. Funds may be added through, for example, a gateway credit card transaction to the merchant's account as shown at step 110 as shown in FIG. 3. Deposited funds become the digital “change” available to the merchant to disburse as change to consumers who use the app and choose to pay for a transaction in cash.

As shown in FIGS. 2-3 a consumers can install an app on their smartphone that allows them to configure a consumer account at step 106. Consumer accounts allow the consumer to shop authorized stores, make purchases, and when paying by cash, have their consumer account identified to the merchant. The consumer's account may be identified using a QR code displayed on the consumer's mobile device that may be read by the merchant's mobile device at 112. The consumer's account may also be identified with direct mobile device to mobile device communications through a network or Bluetooth connectivity or may be found through a search function on the merchant's device. In a particular embodiment, the app can use the location of the two mobile devices when the app is opened to identify a consumer located close to the merchant to initiate communication between the two devices. The devices can be such as, for example, portable computing device, point of sales (“POS”) system, or the like. Each of the above steps can be implemented in a POS system. Other ways of connecting the consumer account to the merchant's account are known to those having skill in the art.

The merchant, in turn, can use their mobile device to identify the consumer's account, by reading the QR code, communicating with the consumer's mobile device, or any other method known by those having skill in the art as shown in 112. Instead of handing the consumer physical change, the merchant and consumer perform an accounting transaction, device to device, and instead of a merchant giving physical coins to the consumer, the physical change is distributed to the consumer electronically, in the form of a credit, and for the merchant, a debit as shown at Steps 114, 116 and 118. Both the consumer and merchant receive confirmation notices of the transaction, completing, and closing the transaction. Since no banking transactions occur, there are no fees to account for in the transaction that can easily swamp the amount of the transaction.

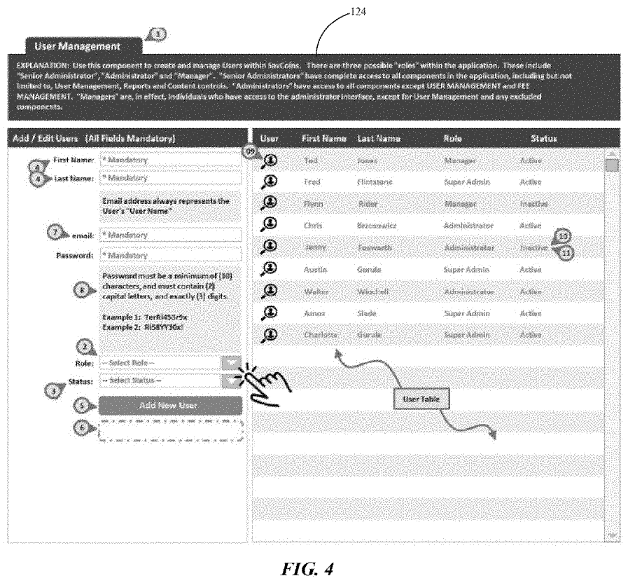

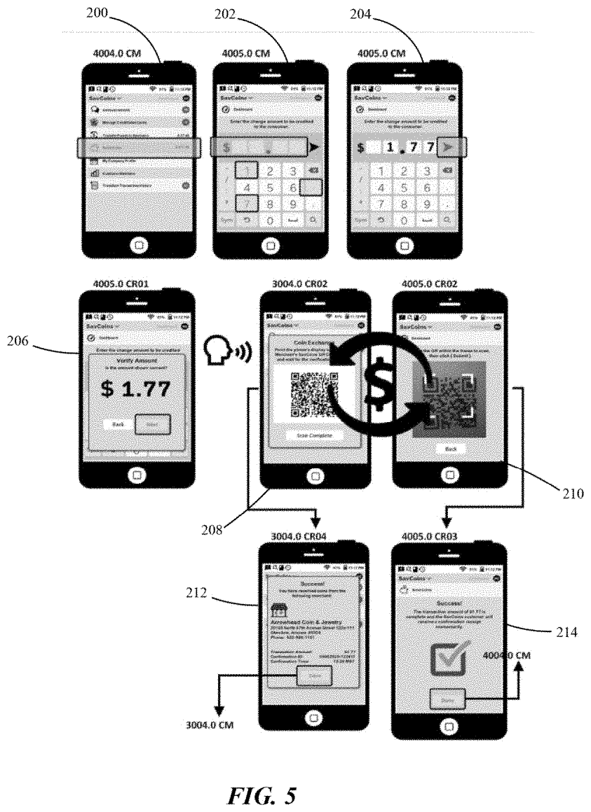

If the change due could involve both paper and coin change, the consumer can choose how much money they wish to have credited to their account and how much they wish to receive as hard cash change. For example, if the amount of change due the consumer was $7.77, then the consumer could choose to receive $5 as cash and $2.77 deposited into their account, receive $7 in cash and have $0.77 deposited into their account, or to have the entire $7.77 deposited into their account. For accounting, a database can track all instances of monetary activity as shown in FIG. 4. At 124 the database would know how much money the merchant has available to disburse as change, and using the consumer identifying technology, knows to which account the funds must be deposited.

As shown at 122 and 124, through the database, each consumer has their own accounting table tracking both credits and debits as shown in FIG. 4. Each time a consumer uses the app at a merchant's store, digital change paid by the merchant to the consumer is credited to the consumer's account. The database tracks every transaction, in perpetuity, from every merchant. Consumers can have hundreds or thousands of transactions on an annual basis and the database records them all, including the merchant, the merchant ID and the merchant's location, city, state, and contact information.

Consumers may decide at what thresholds they will receive their savings. This is accomplished by the consumer choosing between a savings range of $20 to $1,000. As an example, if the consumer chooses a threshold of $500, the database will track and keep a running tally of deposits made to their account, and at the moment their threshold is reached, a notification is sent to the SavCoins web application providing instruction to SavCoins management to whom and where to send the funds. Funds are disbursed by check, electronic direct deposit, money order, or other manner known to those having skill in the art. When a consumer is sent these funds, a debit is applied to reconcile their account. When the consumer receives and deposits their funds, the system will log the date/time that the check cleared, or the funds were entered into the consumer's account. This action debits the consumer's account by the amount of the check and the process repeats.

For the merchant, the conclusion of a transaction using the system creates an overage of their cash tills. Since the system facilitates and allows multiple cashiers to use the platform at the same location simultaneously, the merchant, at the end of the day, and when counting out the tills, will find that each till's cash balance is over, not under. To illustrate this point, assume a merchant with a single cash till conducts five transactions over the course of a day involving the system and assume the transactions are as follows: $1.20, $0.55, $3.78, $0.03, $0.92. Based on these transactions, the total amount paid to consumers is $6.48. This means that the merchant's till should be over by exactly $6.48. The merchant can login and view a Daily Reconciliation Report, a report showing each of the day's transactions, and within this example, can view this day's reconciliation which confirms that $6.48 was paid out to consumers via the application. This validates what the merchant expects to see and allows him/her to complete their daily accounting and prepare for the next day's business. As part of the web application interface, summary reports are available that allow administrative staff to view daily reports detailing (a) all the day's transactions, broken out by either (b) consumers or (c) merchants. Administrators may have the ability to access, view, manage and operate the system through a web-based application system that may be managed from a single Administrator Dashboard.

For marketing purposes, and to allow individuals the ability to download the mobile apps, a website is provided in conjunction with the overall system. The website can be a static site providing information about the platform, how it works and provides, for those viewing the site from their smart phone, the ability to download the mobile app, whether for Android, Apple or other operating system.

At FIG. 5 an example flow process of how the consumer and the merchant interact within the app on their respective portable computing devices. At 200 the merchant selects SavCoins from the app's menu. At 202 the merchant enters the change amount to be credited to the consumer by entering the change amount from the transaction. For example, at step 204 if the merchant purchased an item for $8.23, the merchant enters $1.77 into the field on the mobile device that will be credited to the consumer's account which is taken from the merchant's account that the merchant credited to its account. At 206 the merchant verifies the amount, and the merchant scans the consumers unique QR code as shown at 208 and 210. At 212 the consumer will get a notification that they have received coins from the merchant along with the who the merchant was, the merchant's address and phone number, the transaction amount, and confirmation ID and time the transaction was taken place. At 214 the merchant will receive a similar message confirming the transaction with the amount credited to the consumer's account.

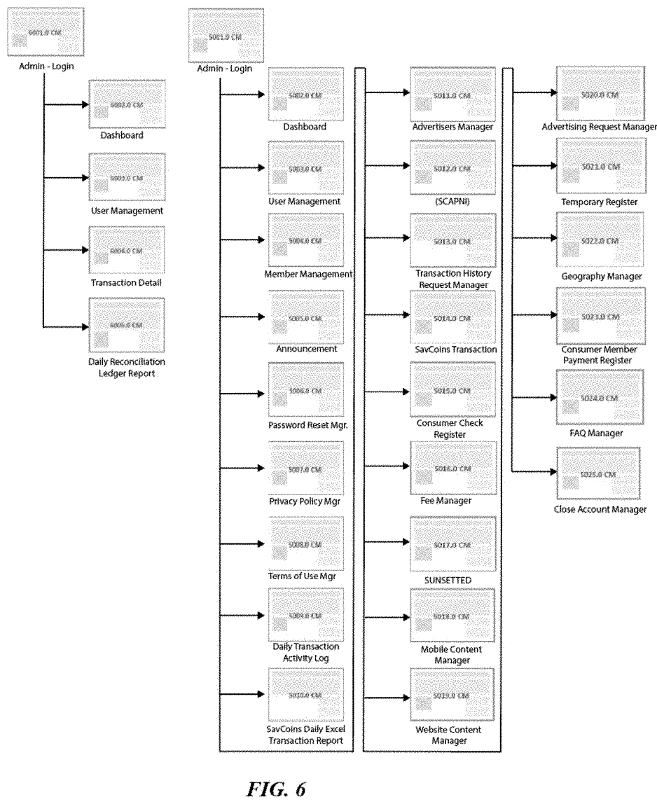

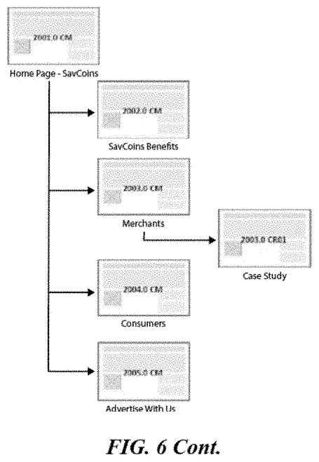

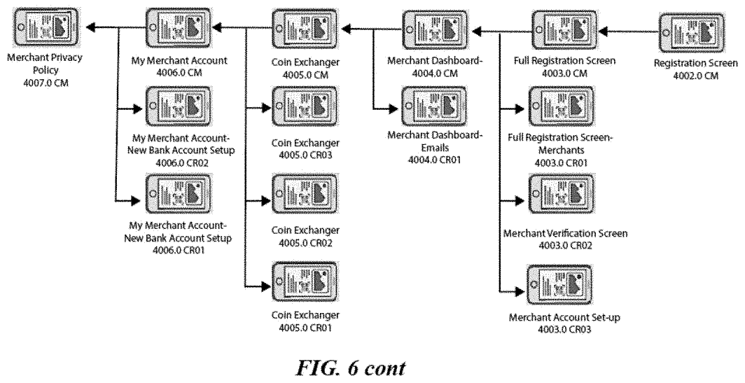

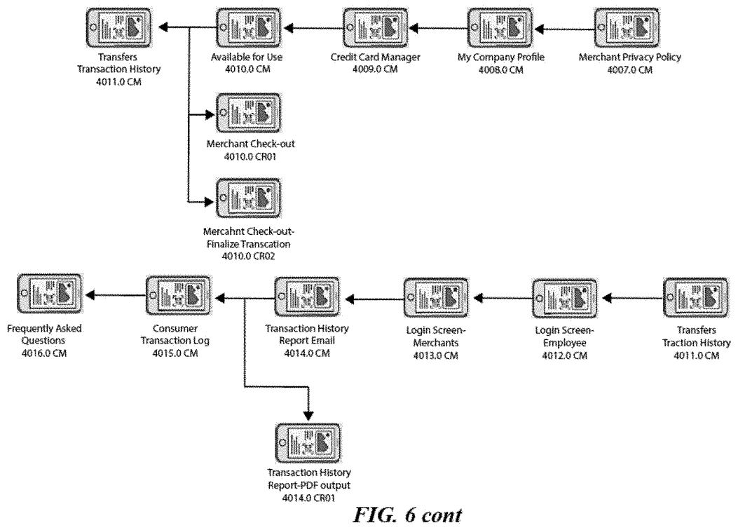

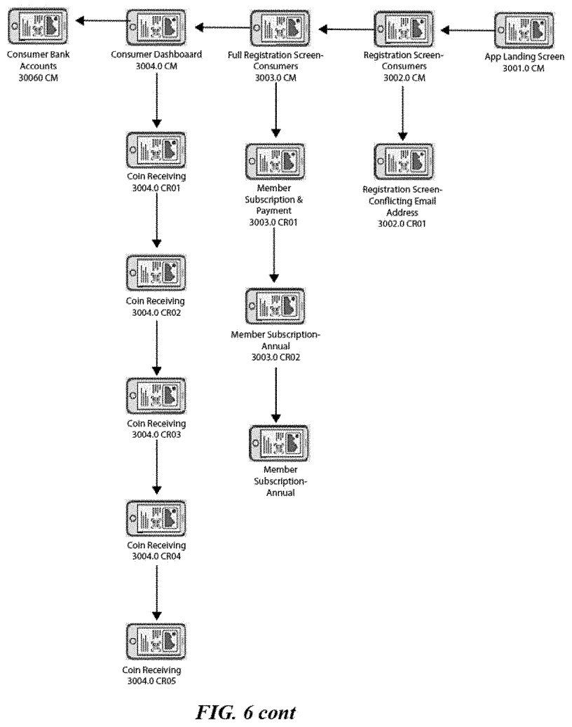

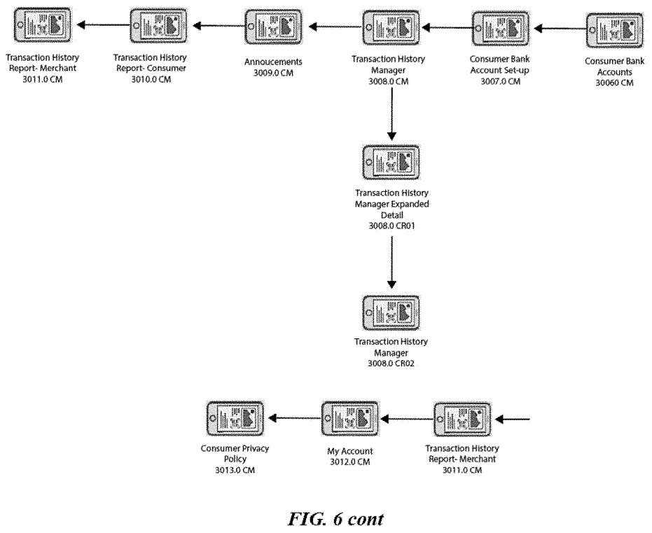

At FIG. 6, shows a wireframe of the process and method using a portable computing device as described above.

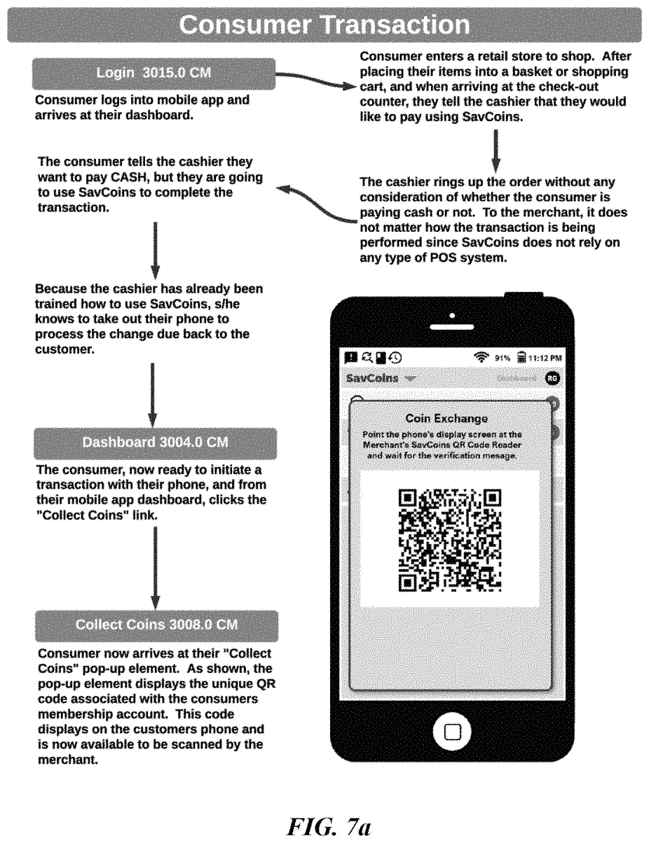

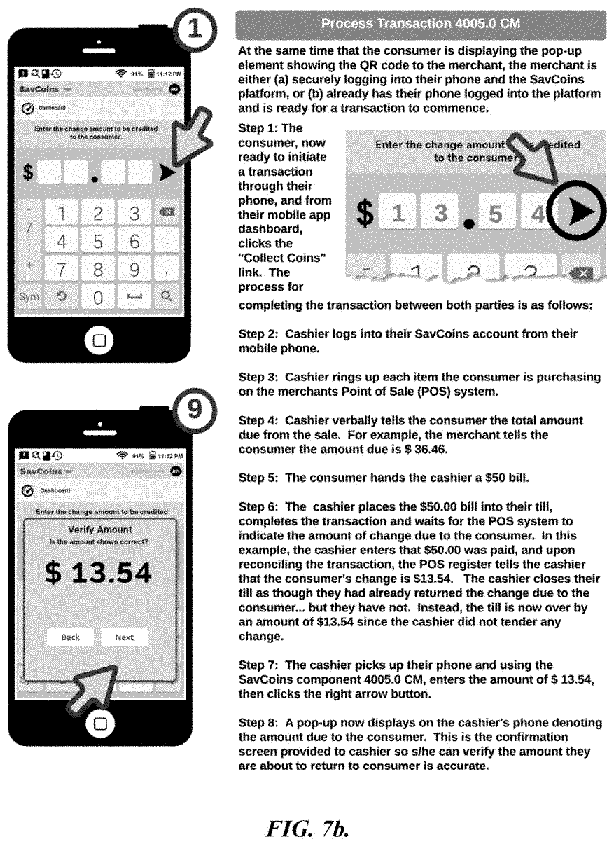

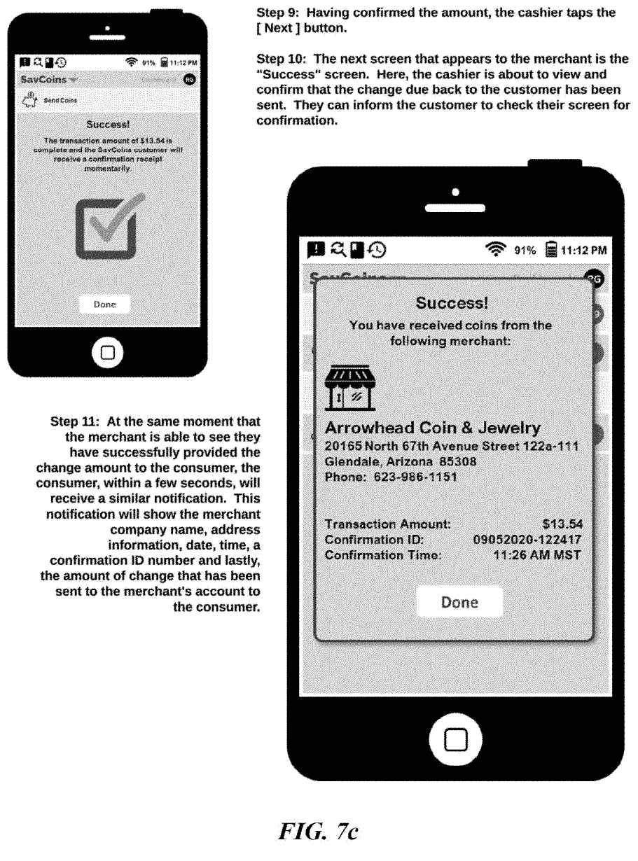

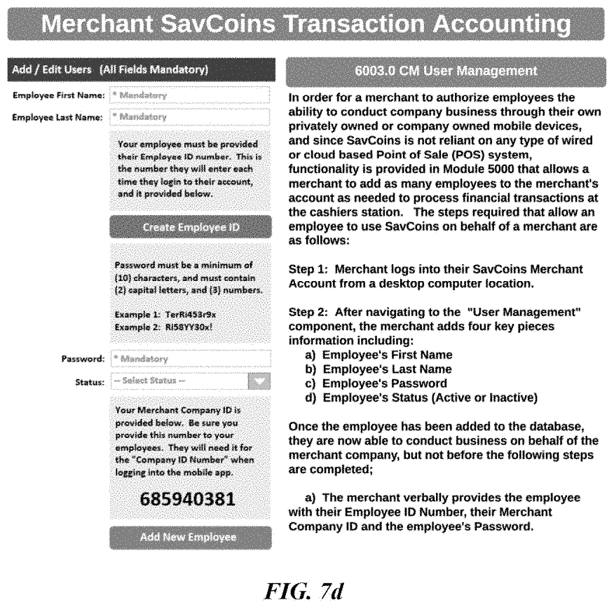

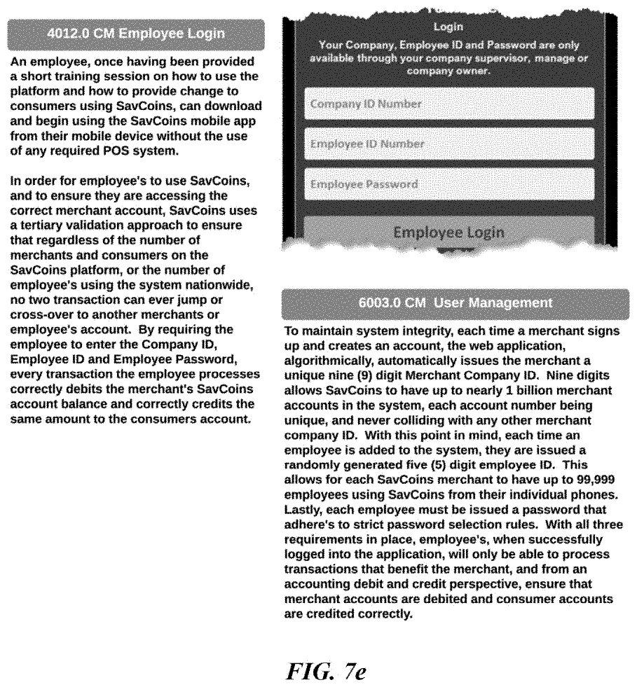

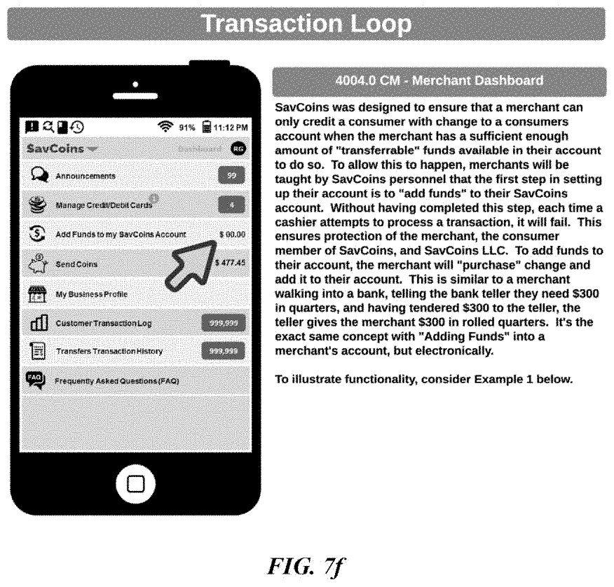

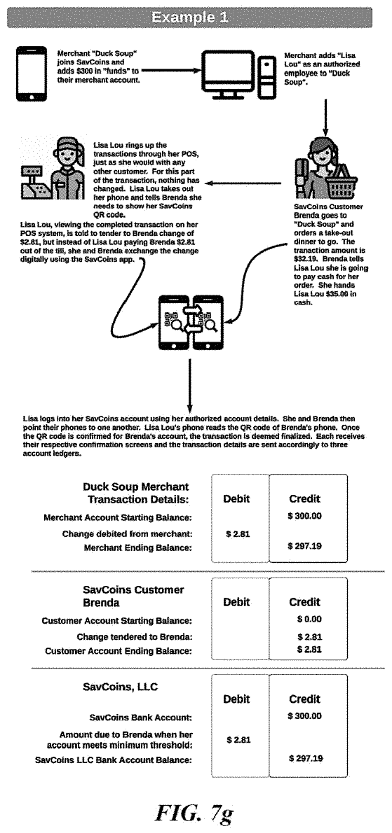

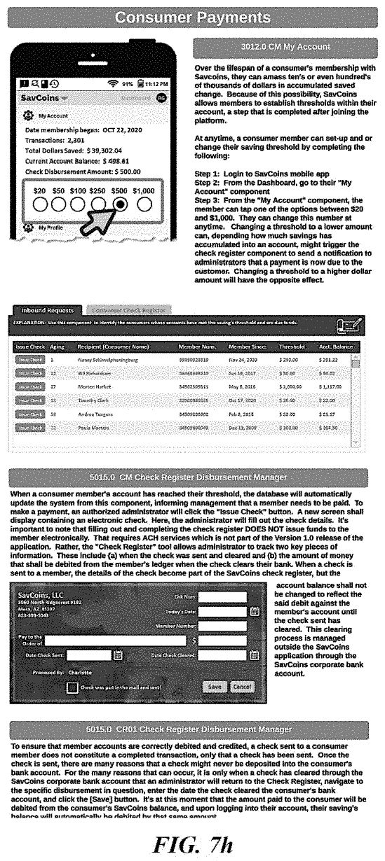

At FIG. 7a-7h, shows a sample flow process and method using a portable computing device of both the merchant and consumer.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A system for digitally processing cash transaction between a vendor using a vendor device and a consumer using a consumer device, wherein the transaction comprises a transaction amount and a cash amount greater than the transaction amount defining a change amount that is the difference between the cash amount and the transaction amount, the system comprising:
an accounting platform on a system device comprising at least one vendor account associated with a vendor profile and a plurality of consumer accounts associated with a plurality of consumer profiles;
a vendor application program on the vendor device associated with the at least one vendor profile and comprising a vendor interface, wherein the vendor can add money to the vendor account through the vendor interface and wherein the vendor can enter the transaction amount and the cash amount into the vendor interface;
a consumer application program on the consumer device associated with at least one of the plurality of consumer profiles and comprising a consumer identifier that identifies the consumer account, wherein the consumer device uses the consumer application program to communicates the consumer identifier to the vendor device through the vendor application program, and the vendor account initiates a request to debit at least some of the change amount from the vendor account and credit the same amount to the consumer account; and
a processor on the system device that credits and debits vendor accounts and consumer accounts on the system device and in response to requests received from at least one of the vendor application program and the consumer application program and initiates issuance of a check or credit to an outside banking account of the consumer when the consumer account reaches a predetermined balance.

2. The system of claim 1 wherein the amount that is requested to be debited from the vendor account and credited to the consumer account is entered into the vendor interface.

3. The system of claim 1 wherein the vendor device and the consumer device each comprise a display, wherein the consumer identifier is communicated by displaying a QR code on the consumer device and reading the QR code on the vendor device.

4. The system of claim 1 wherein money is added to the vendor account through a gateway credit card transaction.

5. The system of claim 1 wherein the vendor device and the consumer device are both smart phones.

6. The system of claim 1 wherein the processor initiates a notice to the vendor and the consumer confirming the completed transaction.

7. The system of claim 1 wherein the predetermined balance is selected by the consumer on the consumer interface.

8. The system of claim 1 wherein the vendor application program tallies the amount of change debited from the vendor account over a period of time.

9. The system of claim 1 further comprising an administrator application program allowing an administrator to access, view, manage, and operate the accounting platform.

10. The system of claim 9, wherein the administrator application program is one of a web-based application system and a device-based application system.

11. The system of claim 9 wherein the administrator application program comprises an administrator dashboard.

12. The system of claim 1 wherein the vendor application program allows the vendor to manage access to the vendor profile.

13. The system of claim 1 wherein the vendor interface comprises a web application interface and a device application interface.

14. A method for at least partially eliminating change in a cash transaction between a vendor using a vendor device and a consumer using a consumer device, wherein the transaction comprises a transaction amount and a cash amount greater than the transaction amount defining a change amount that is the difference between the cash amount and the transaction amount, the method comprising:
hosting an accounting platform on a system device comprising at least one vendor account associated with a vendor profile and a plurality of consumer accounts associated with a plurality of consumer profiles;
distributing a vendor application program to the vendor device wherein the vendor application program is associated with the at least one vendor profile and comprising a vendor interface, wherein the vendor can add money to the vendor account through the vendor interface and wherein the vendor can enter the transaction amount and the cash amount into the vendor interface;
distributing a consumer application program to the consumer device, the consumer application program being associated with at least one of the plurality of consumer profiles and comprising a consumer identifier that identifies the consumer account, wherein the consumer device uses the consumer application program to communicate the consumer identifier to the vendor device and the vendor application program, and the vendor account initiates a request to debit at least some of the change amount from the vendor account and credit the same amount to the consumer account; and
crediting and debiting vendor accounts and consumer accounts in response to requests received from at least one of the vendor application program and the consumer application program and initiating issuance of a check or credit to an outside banking account of the consumer when the consumer account reaches a predetermined balance.

15. The method of claim 14 further comprising receiving money into the vendor account through a gateway credit card transaction.

16. The method of claim 14 wherein the vendor application program and the consumer application program are distributed as mobile apps.

17. The method of claim 14 further comprising initiating a notice to the vendor and the consumer confirming the completed transaction.

18. The method of claim 14 further comprising tallying the amount of change debited from the vendor account over a period of time.

19. The method of claim 14 further comprising providing an administrator application program allowing an administrator to access, view, manage, and operate the accounting platform.

20. The method of claim 14, further comprising initiating communication of the consumer identifier between the consumer device and the vendor device in response to a prompt from the consumer device.
